(19) United States
(12) Patent Application Publication
(10) Pub. No.: US 2013/0265274 A1
(43) Pub. Date: Oct. 10, 2013

(54) CAPACITIVE TOUCH PANEL

(71) Applicants: Hu-Yi LIU, Taoyuan County (TW); Shih-Hung HUANG, Taoyuan County (TW); Hung-Hsiang CHEN, Taoyuan County (TW)

(72) Inventors: Hu-Yi LIU, Taoyuan County (TW); Shih-Hung HUANG, Taoyuan County (TW); Hung-Hsiang CHEN, Taoyuan County (TW)

(73) Assignee: CHUNGHWA PICTURE TUBES, LTD., TAOYUAN (TW)

(21) Appl. No.: 13/553,792

(22) Filed: Jul. 19, 2012

(30) Foreign Application Priority Data
Apr. 9, 2012 (TW) 101112476

(51) Int. Cl. G06F 3/044

(52) U.S. Cl. 345/174

(57) ABSTRACT

A capacitive touch panel is provided. The capacitive touch panel comprises a substrate, a plurality columns of first directional sensing electrodes, a plurality rows of second directional sensing electrodes and an optical compensation structure. Each two neighboring first directional sensing electrodes in each of the columns are connected with a connecting structure in series. The first and the second directional sensing electrodes are arranged in a staggered manner. Each two neighboring second directional sensing electrodes in each of the rows are connected with a bridging structure in series without contacting the connecting structure. A gap is presented between each of the second directional sensing electrodes and its neighboring first directional sensing electrodes and the optical compensation structure having a specific thickness is formed therein such that a light-penetrability of the optical compensation structure is substantially the same as that of the first and the second directional sensing electrodes.

### RELATED APPLICATIONS

This application claims priority to Taiwan Application Serial Number 101112476, filed Apr. 9, 2012, which is herein incorporated by reference.

### BACKGROUND

1. Technical Field

The present invention relates to touch panel technology. More particularly, the present invention relates to a capacitive touch panel including an optical compensation structure having a specific thickness such that a light-penetrability of the optical compensation structure is substantially the same as that of sensing electrodes of the capacitive touch panel.

2. Description of Related Art

The consumer electronic products are becoming popular as they offer some sophisticated features that are useful to people in their daily life. Hence, the manufacturers keep designing new smartphones and the tablet PCs. Most of these electronic devices are equipped with touch devices since the touch input devices are intuitive to the users and quickly become mainstream. The touch panels can be categorized into the resistive touch panels, the capacitive touch panels and the supersonic touch panels, wherein capacitive touch panels are most common products.

When a finger (or a conductive object) touches the substrate of the capacitive touch panel, the sensing electrodes in a staggered manner can sense the change of the electrical properties related to the electrostatic field and transmit the sensed signal to a sensing circuit such that the sensing circuit determines the touch position of the finger (or the object). However, in order to avoid the false detection, a gap is formed between each of the sensing electrodes to provide an insulating effect. If the width of the gap is too small, the interference between the sensing electrodes will affect the sensibility and the accuracy of the capacitive touch panel. If the width of the gap is too large, the uneven light-penetrability of the gap and the sensing electrodes results in grid phenomenon on the panel.

Accordingly, what is needed is a capacitive touch panel to addresses the issues described above.

### SUMMARY

An aspect of the present invention is to provide a capacitive touch panel. The capacitive touch panel comprises a substrate, a plurality columns of first directional sensing electrodes, a plurality rows of second directional sensing electrodes and an optical compensation structure. Each two of the neighboring first directional sensing electrodes in each of the columns are connected in series through a connecting structure. The rows of the second directional sensing electrodes and the columns of the first directional sensing electrodes are arranged in a staggered manner. Each two of the neighboring second directional sensing electrodes in each of the rows are connected in series through a bridging structure that does not contact the connecting structure. An electrode gap is presented between each of the second directional sensing electrodes and its neighboring first directional sensing electrodes. The optical compensation structure is formed in the electrode gap, wherein the optical compensation structure has a specific thickness such that a light-penetrability of the optical compensation structure is substantially the same as that of the first directional sensing electrodes and the second directional sensing electrodes.

In an embodiment of the present invention, an insulating layer is formed between the connecting structure and the corresponding bridging structure.

In an embodiment of the present invention, the insulating layer is formed of organic photo resist or SiO2.

In an embodiment of the present invention, the insulating layer and the optical compensation structure is formed of the same material.

In an embodiment of the present invention, the connecting structure in each two of the neighboring first directional sensing electrodes is formed on the substrate and the insulating layer is formed on the connecting structure.

In an embodiment of the present invention, the bridging structure connects the second directional sensing electrodes across the insulating layer.

In an embodiment of the present invention, the insulating layer covers the connecting structure, the first directional sensing electrodes and the second directional sensing electrodes such that the bridging structure connects the second directional sensing electrodes across the insulating layer through a plurality of through holes.

In an embodiment of the present invention, the bridging structure is formed on the substrate, the insulating layer is formed on the bridging structure and the connecting structure connects the first directional sensing electrodes across the insulating layer.

In an embodiment of the present invention, the optical compensation structure is fully filled in the electrode gap.

In an embodiment of the present invention, the bridging structure is a metal wire or a conducting glass.

In an embodiment of the present invention, the capacitive touch panel further comprises a protective layer covering the first directional sensing electrodes, the second directional sensing electrodes and the optical compensation structure.

In an embodiment of the present invention, each of the columns of first directional sensing electrodes and the rows of the second directional sensing electrodes is electrically connected to a wire to be further electrically connected to a sensing circuit.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a top view of a capacitive touch panel in an embodiment of the present invention;

FIG. 1B is a partially enlarged diagram of the capacitive touch panel in FIG. 1A in an embodiment of the present invention;

FIG. 2A is a cross-sectional diagram of the capacitive touch panel along a line A-A in FIG. 1B;

FIG. 2B is a cross-sectional diagram of the capacitive touch panel along a line B-B in FIG. 1B;

FIG. 2C is a cross-sectional diagram of the capacitive touch panel along a line C-C in FIG. 1B;

FIG. 3 is a partially enlarged diagram of the capacitive touch panel in FIG. 1A in another embodiment of the present invention;

FIG. 4A is a cross-sectional diagram of the capacitive touch panel along a line A-A in FIG. 3;

FIG. 4B is a cross-sectional diagram of the capacitive touch panel along a line B-B in FIG. 3;

FIG. 4C is a cross-sectional diagram of the capacitive touch panel along a line C-C in FIG. 3;

FIG. 5 is a partially enlarged diagram of the capacitive touch panel in FIG. 1A in another embodiment of the present invention;

FIG. 6A is a cross-sectional diagram of the capacitive touch panel along a line A-A in FIG. 5;

FIG. 6B is a cross-sectional diagram of the capacitive touch panel along a line B-B in FIG. 5; and

FIG. 6C is a cross-sectional diagram of the capacitive touch panel along a line C-C in FIG. 5.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

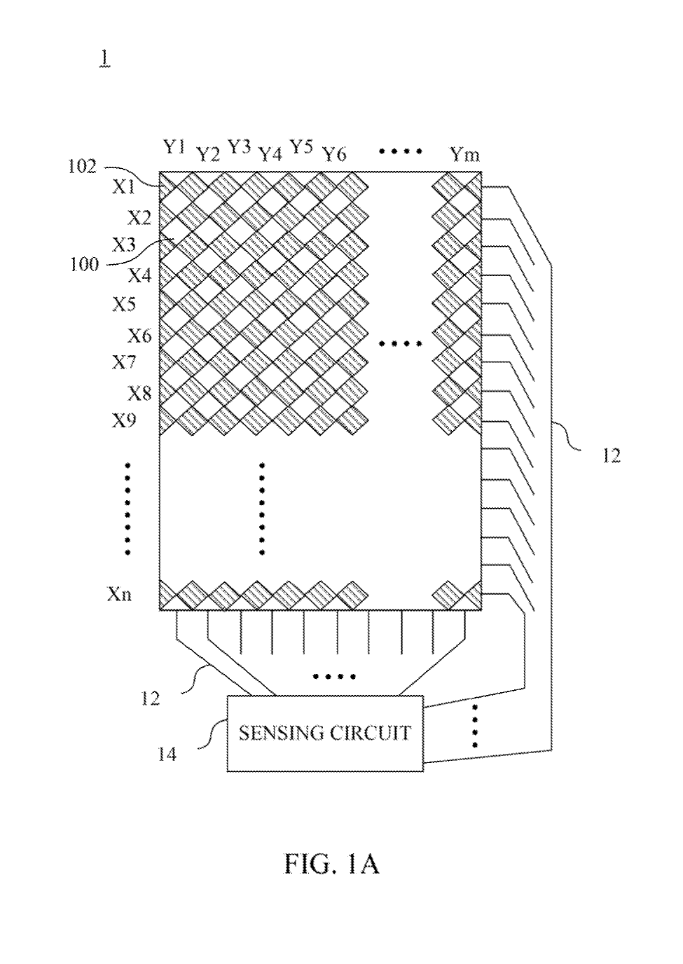

FIG. 1A is a top view of a capacitive touch panel 1 in an embodiment of the present invention. The capacitive touch panel comprises a plurality columns of first directional sensing electrodes 100 labeled as Y1, Y2, . . . ,Ym and a plurality rows of second directional sensing electrodes 102 labeled as X1, X2, . . . , Xn, a plurality of wires 12 and a sensing circuit 14.

The first directional sensing electrodes 100 in each columns Y1, Y2, . . . , Ym are connected in series along a first direction. The second directional sensing electrodes 102 in each rows X1, X2, . . . , Xn are connected in series along a second direction. When a finger (or a conductive object) touches the substrate of the capacitive touch panel 1, the first directional sensing electrodes 100 and the second directional sensing electrodes 102 arranged in a staggered manner can sense the change of the electrical properties related to the electrostatic field. The first directional sensing electrodes 100 and the second directional sensing electrodes 102 further transmit the sensed signal to the sensing circuit 14 through the wires 12. The sensing circuit 14 then determines the touch position of the finger (or the object).

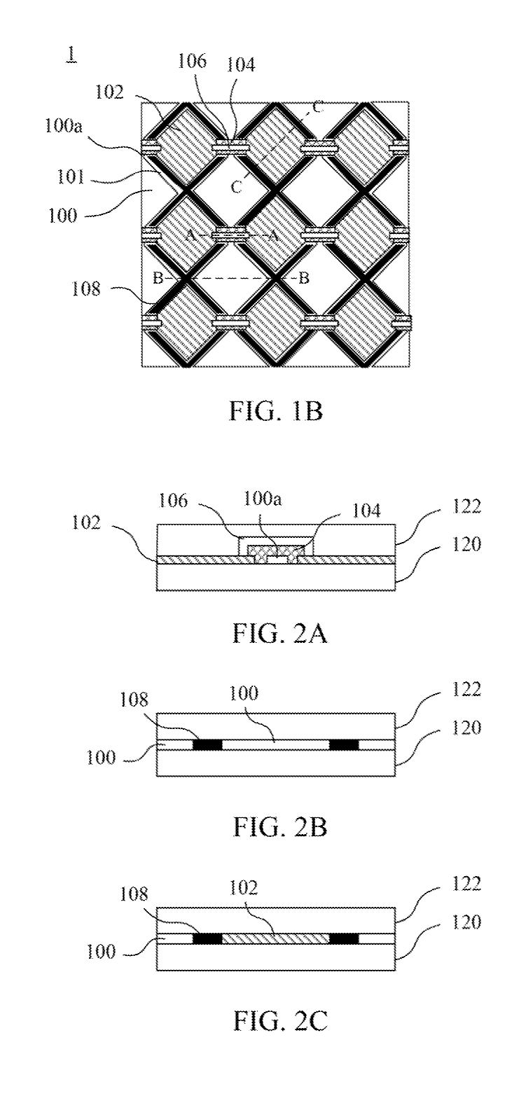

FIG. 1B is a partially enlarged diagram of the capacitive touch panel 1 in FIG. 1A in an embodiment of the present invention. FIG. 2A is a cross-sectional diagram of the capacitive touch panel 1 along a line A-A in FIG. 1B. FIG. 2B is a cross-sectional diagram of the capacitive touch panel 1 along a line B-B in FIG. 1B. FIG. 2C is a cross-sectional diagram of the capacitive touch panel 1 along a line C-C in FIG. 1B. As shown in FIG. 1B, FIG. 2A, FIG. 2B and FIG. 2C, in addition to the first directional sensing electrodes 100 and the second directional sensing electrodes 102, the capacitive touch panel 1 further comprises a substrate 120, a connecting structure 100a, an insulating layer 104, a bridging structure 106 and an optical compensation structure 108.

The first directional sensing electrodes 100 are formed on the substrate 120. Each two of the neighboring first directional sensing electrodes 100 in each of the columns are connected in series through the connecting structure 100a. In the present embodiment, the connecting structure 100a and the first directional sensing electrodes 100 are formed of the same material and are formed simultaneously on the substrate 120.

The second directional sensing electrodes 102 and the first directional sensing electrodes 100 are arranged in a staggered manner, in which the second directional sensing electrodes 102 are formed on the substrate 120 as well. Each two of the neighboring second directional sensing electrodes 102 in each of the rows are connected in series through the bridging structure 106 that does not contact the connecting structure 100a. In an embodiment, the bridging structure 106 is formed of metal. In other embodiments, the bridging structure 106 can be formed of the same material as the transparent electrode of the second directional sensing electrodes 102 such as ITO. In an embodiment, the insulating layer 104 is formed between the connecting structure 100a and the bridging structure 106 to prevent the bridging structure 106 contacting the 25. connecting structure 100a. Therefore, the bridging structure 106 can electrically connect the second directional sensing electrodes 102 across the insulating layer 104. It is noted that the first directional sensing electrodes 100 and the second directional sensing electrodes 102 are depicted in the shape of diamond. In other embodiments, the first directional sensing electrodes 100 and the second directional sensing electrodes 102 can be formed in other shapes.

An electrode gap 101 is presented between each of the second directional sensing electrodes 102 and its neighboring first directional sensing electrodes 100. The optical compensation structure 108 is formed in the electrode gap 101, wherein the optical compensation structure 108 has a specific thickness such that a light-penetrability of the optical compensation structure 108 is substantially the same as that of the first directional sensing electrodes 100 and the second directional sensing electrodes 102. It is noted that the term “substantially the same” means that the light-penetrability of the optical compensation structure 108 and the light-penetrability of the first directional sensing electrodes 100 and the second directional sensing electrodes 102 are not limited to be exactly the same. The light-penetrability of the optical compensation structure 108 and the light-penetrability of the first directional sensing electrodes 100 and the second directional sensing electrodes 102 can have a difference within a reasonable range.

In an embodiment, the light-penetrability of the first directional sensing electrodes 100 and the second directional sensing electrodes 102 is about 96%-97% when their thickness is ranged in 150-200 Å. The light-penetrability of the optical compensation structure 108 can reach 97% when it is formed of insulating material such as organic photo resist or SiO2 and has a thickness of 2900 Å. Hence, the electrode gap 101 filled with the optical compensation structure 108 can have the light-penetrability similar to that of the first directional sensing electrodes 100 and the second directional sensing electrodes 102. The grid generated due to the uneven light-penetrability of the capacitive touch panel 1 can be avoided. The insulating material used to form the optical compensation structure 108 can prevent the electrical interference between the first directional sensing electrodes 100 and the second directional sensing electrodes 102 when the width is much smaller. When the width between the first directional sensing electrodes 100 and the second directional sensing electrodes 102 is larger, the optical compensation structure 108 can compensate the uneven light-penetrability. Therefore, the width of the electrode gap 101 can be designed elastically according to the required sensibility and the accuracy of the capacitive touch panel 1.

In an embodiment, the optical compensation structure 108 is formed of the same material used to fabricate the insulating layer 104 (e.g. organic photo resist or SiO2) between the connecting structure 100a and the bridging structure 106 and is formed simultaneously with the insulating layer 104. In other words, the compensation structure 108 and the insulating layer 104 can be formed simultaneously and respectively in the electrode gap 101 and on the connecting structure 100a after the first directional sensing electrodes 100 and the second directional sensing electrodes 102 are formed on the substrate 120. The bridging structure 106 can be further formed to connect each two of the second directional sensing electrodes 102 in series. In the present embodiment, a protective layer 122 is further formed to cover the first directional sensing electrodes 100 and the second directional sensing electrodes 102 and the optical compensation structure 108 to protect the capacitive touch panel 1.

It is noted that in an embodiment, the electrode gap 101 can be partially filled with the optical compensation structure 108 as shown in FIG. 1B. In other embodiments, the electrode gap 101 can be fully filled with the optical compensation structure 108 such that the grid generated due to the uneven light-penetrability of the capacitive touch panel 1 can be avoided.

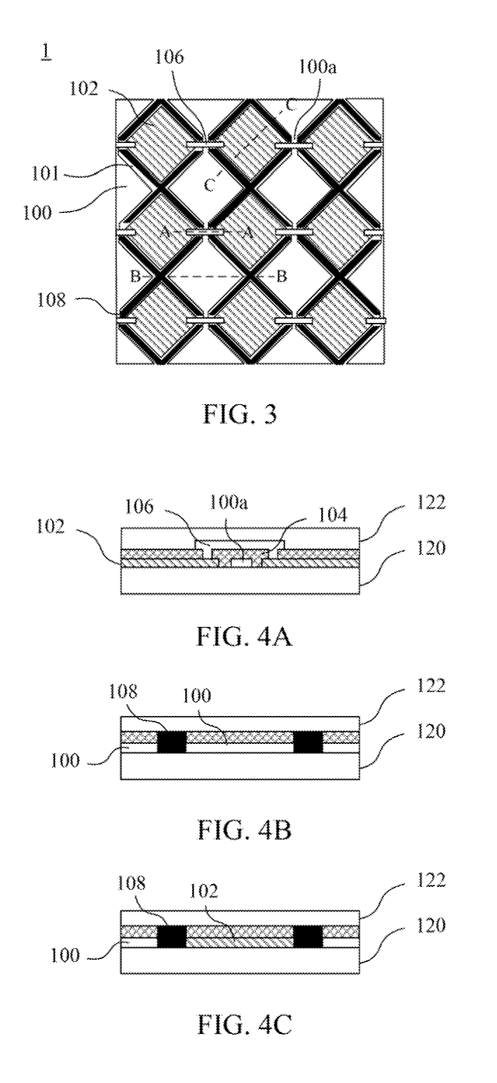

FIG. 3 is a partially enlarged diagram of the capacitive touch panel 1 in FIG. 1A in another embodiment of the present invention. FIG. 4A is a cross-sectional diagram of the capacitive touch panel 1 along a line A-A in FIG. 3. FIG. 4B is a cross-sectional diagram of the capacitive touch panel 1 along a line B-B in FIG. 3. FIG. 4C is a cross-sectional diagram of the capacitive touch panel 1 along a line C-C in FIG. 3.

In the present embodiment, the connecting structure 100a is made of the same material as the first directional sensing electrodes 100 and is formed simultaneously with the first directional sensing electrodes 100 (similar to the connecting structure 100a in the previous embodiment). In the present embodiment, the insulating layer 104 actually covers the connecting structure 100a, the first directional sensing electrodes 100 and the second directional sensing electrodes 102. It is noted that in order to clearly depict the relation between the first directional sensing electrodes 100 and the second directional sensing electrodes 102 and the optical compensation structure 108, the insulating layer 104 is not shown in FIG. 3. Therefore, the bridging structure 106 in the present embodiment can connect each two the second directional sensing electrodes 102 across the insulating layer 104 through a plurality of through holes. Similarly, the optical compensation structure 108 and the insulating layer 104 can be formed of the same material. The protective layer 122 is then formed to cover the first directional sensing electrodes 100 and the second directional sensing electrodes 102 and the optical compensation structure 108 to protect the capacitive touch panel 1.

Similarly, it is noted that in an embodiment, the electrode gap 101 can be partially filled with the optical compensation structure 108 as shown in FIG. 3. In other embodiments, the electrode gap 101 can be fully filled with the optical compensation structure 108 such that the grid generated due to the uneven light-penetrability of the capacitive touch panel 1 can be avoided.

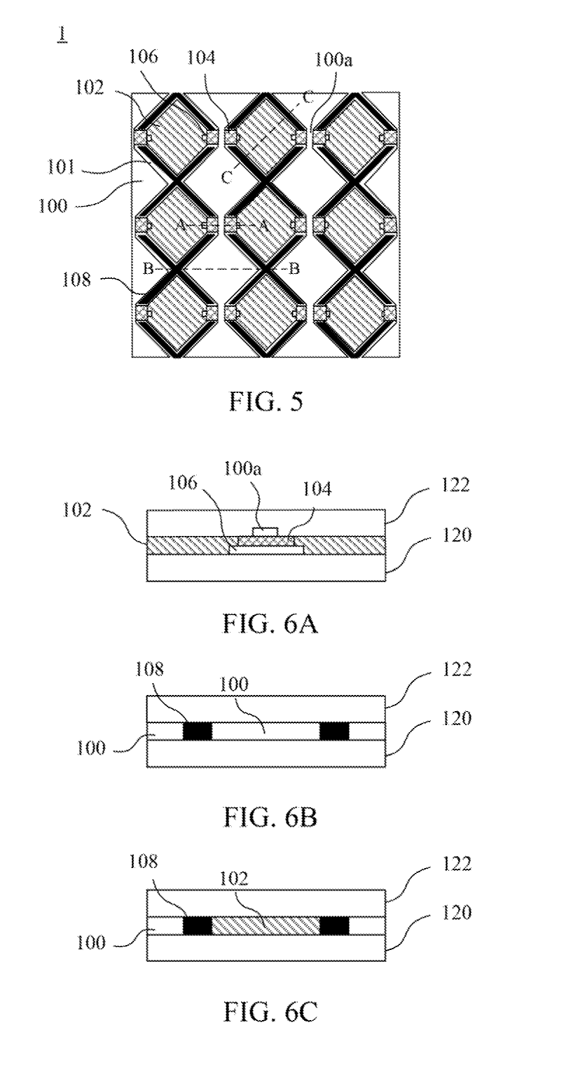

FIG. 5 is a partially enlarged diagram of the capacitive touch panel 1 in FIG. 1A in another embodiment of the present invention. FIG. 6A is a cross-sectional diagram of the capacitive touch panel 1 along a line A-A in FIG. 5. FIG. 6B is a cross-sectional diagram of the capacitive touch panel 1 along a line B-B in FIG. 5. FIG. 6C is a cross-sectional diagram of the capacitive touch panel 1 along a line C-C in FIG. 5.

In the present embodiment, the bridging structure 106 is formed on the substrate 120 at first. The first directional sensing electrodes 100 and the second directional sensing electrodes 102 are subsequently formed. After forming the first directional sensing electrodes 100 and the second directional sensing electrodes 102, the insulating layer 104 is formed on the bridging structure 106 and the optical compensation structure 108 is formed in the electrode gap 101. Subsequently, the connecting structure 100a connects each two the first directional sensing electrodes 100 across the insulating layer 104. The protective layer 122 is then formed to cover the first directional sensing electrodes 100 and the second directional sensing electrodes 102 and the optical compensation structure 108 to protect the capacitive touch panel 1.

Similarly, it is noted that in an embodiment, the electrode gap 101 can be partially filled with the optical compensation structure 108 as shown in FIG. 5. In other embodiments, the electrode gap 101 can be fully filled with the optical compensation structure 108 such that the grid generated due to the uneven light-penetrability of the capacitive touch panel 1 can be avoided.

From the above embodiments, it is known that the capacitive touch panel 1 in the present invention can keep the optical characteristic of the optical compensation structure 108 similar to that of the first directional sensing electrodes 100 and the second directional sensing electrodes 102. Especially, the light-penetrability of the optical compensation structure 108 is substantially equal to that of the first directional sensing electrodes 100 and the second directional sensing electrodes 102, to avoid the generation of the grid. Further, the optical compensation structure 108 can be fabricated simultaneously with the insulating layer 104 and can be integrated in different fabrication processes without increasing the cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A capacitive touch panel comprising:
a substrate;
a plurality columns of first directional sensing electrodes, wherein each two of the neighboring first directional sensing electrodes in each of the columns are connected in series through a connecting structure;
a plurality rows of second directional sensing electrodes, wherein the rows of the second directional sensing electrodes and the columns of the first directional sensing electrodes are arranged in a staggered manner, each two of the neighboring second directional sensing electrodes in each of the rows are connected in series through a bridging structure that does not contact the connecting structure and an electrode gap is presented between each of the second directional sensing electrodes and its neighboring first directional sensing electrodes; and
an optical compensation structure formed in the electrode gap, wherein the optical compensation structure has a specific thickness such that a light-penetrability of the optical compensation structure is substantially the same as that of the first directional sensing electrodes and the second directional sensing electrodes.

2. The capacitive touch panel of claim 1, wherein an insulating layer is formed between the connecting structure and the corresponding bridging structure.

3. The capacitive touch panel of claim 2, wherein the insulating layer is formed of organic photo resist or SiO2.

4. The capacitive touch panel of claim 2, wherein the insulating layer and the optical compensation structure is formed of the same material.

5. The capacitive touch panel of claim 2, wherein the connecting structure in each two of the neighboring first directional sensing electrodes is formed on the substrate and the insulating layer is formed on the connecting structure.

6. The capacitive touch panel of claim 4, wherein the bridging structure connects the second directional sensing electrodes across the insulating layer.

7. The capacitive touch panel of claim 4, wherein the insulating layer covers the connecting structure, the first directional sensing electrodes and the second directional sensing electrodes such that the bridging structure connects the second directional sensing electrodes across the insulating layer through a plurality of through holes.

8. The capacitive touch panel of claim 2, wherein the bridging structure is formed on the substrate, the insulating layer is formed on the bridging structure and the connecting structure connects the first directional sensing electrodes across the insulating layer.

9. The capacitive touch panel of claim 1, wherein the optical compensation structure is fully filled in the electrode gap.

10. The capacitive touch panel of claim 1, wherein the bridging structure is a metal wire or a conducting glass.

11. The capacitive touch panel of claim 1, further comprising a protective layer covering the first directional sensing electrodes, the second directional sensing electrodes and the optical compensation structure.

12. The capacitive touch panel of claim 1, wherein each of the columns of first directional sensing electrodes and the rows of the second directional sensing electrodes is electrically connected to a wire to be further electrically connected to a sensing circuit.
